(19) United States
(12) Patent Application Publication
(10) Pub. No.: US 2025/0037184 A1
(43) Pub. Date: Jan. 30, 2025

(54) MATCHING PRODUCT INFORMATION ACROSS MULTIPLE CHANNELS

(71) Applicant: INTUIT INC., Mountain View, CA (US)

(72) Inventors: Saket MALVIYA, Mountain View, CA (US); William Mirie KIMERIA, Mountain View, CA (US)

(73) Assignee: INTUIT INC., Mountain View, CA (US)

(21) Appl. No.: 18/360,746

(22) Filed: Jul. 27, 2023

(51) Int. Cl. G06Q 30/0601; G06N 5/048

(52) U.S. Cl. CPC G06Q 30/0631; G06N 5/048

(57) ABSTRACT

Systems and methods for matching received product information with stored product information. Incoming product information has multiple attributes, which may be fuzzy matched with corresponding attributes of stored product information to generate corresponding fuzzy matching scores. Each of the fuzzy matching scores is associated with a weighting factor, which is used to indicate a contribution of the corresponding fuzzy matched attribute to a match between the entire product information. A matching coefficient is initialized and progressively updated by using the weighted fuzzy matching scores. When a desired number of fuzzy matchings between the corresponding attributes is reached and the matching coefficient is finalized, the matching coefficient is compared to a threshold. If the matching coefficient is above the threshold, a recommendation is generated indicating a match between the received product information and the stored product information.

### BACKGROUND

Computer networks such as the Internet have significantly changed electronic commerce over the past few decades. The principal changes—and improvements—are flexibility and convenience. On the consumer side, information about products is readily available at webpages that can be accessed from multiple devices, at multiple locations, and at any time. Additionally, information about similar products or recommended products can be readily accessed. On the merchant side, information about products can be published across various channels (e.g., shopping platforms such as Amazon® or Etsy®) targeted for different types of consumers.

Such flexibility and convenience, however, generate their own technical challenges. For example, a merchant may list the same product with different attributes for different channels. To take a simple example, a “candle” product may be listed as a “flavored candle” at Amazon®, as a “scented candle” at Etsy®, and as a “good vibes candle” at Target®. There may be other attributes imposed by the channels—each of which may provide their own identification numbers for the same products. Additionally, the descriptions and other identifying information about a product may differ. Therefore, a single product is presented with different pieces of information across the different channels. A significant technical challenge is to track activities (e.g., sales, returns, discounts, etc.) across these different channels.

Conventional matching and tracking systems have been less than satisfactory. For example, a merchant may manually maintain a list of the different types of descriptions for the products, and check the list each time a transaction information comes in. Some portion of this checking and matching may be automated, however, the list, which acts as a reference for the checking and the matching, has to be manually constructed. Furthermore, the list has to be manually updated if new products are added and/or if descriptions about current products are changed. All of these are undesirable.

Therefore, a significant improvement on matching product information across different channels is desired.

### SUMMARY

Embodiments disclosed herein solve the aforementioned technical problems and may provide other technical solutions as well. Incoming product information has multiple attributes, e.g., stock keeping unit (SKU) of the product, product name, product description, etc., which may be fuzzy matched with corresponding attributes of stored product information to generate corresponding fuzzy matching scores. Each of the fuzzy matching scores is associated with a weighting factor, which is used to indicate a contribution of the corresponding fuzzy matched attribute to a match between the entire product information. A matching coefficient is initialized and progressively updated by using the weighted fuzzy matching scores. When a desired number of fuzzy matchings between the corresponding attributes is reached and the matching coefficient is finalized, the matching coefficient is compared to a threshold. If the matching coefficient is above the threshold, a recommendation is generated indicating a match between the received product information and the stored product information. If the matching coefficient is below the threshold, no such recommendation is made.

### BRIEF DESCRIPTION OF THE DRAWINGS

FIG. 1 shows an example of a system configured for matching product information across multiple channels based on the principles disclosed herein.

FIG. 2 shows a flow diagram of an example method of matching product information across multiple channels based on the principles disclosed herein.

FIGS. 3A-3B show example graphical user interfaces showing recommended matches based on the principles disclosed herein.

FIG. 4 shows a block diagram of an example computing device that implements various features and processes based on the principles disclosed herein.

### DETAILED DESCRIPTION OF SEVERAL EMBODIMENTS

Embodiments disclosed herein determine whether received product information matches stored product information to avoid duplicative storage. The determination is made by fuzzy matching corresponding attributes of the received product information with the stored product information, augmenting the weight of the fuzzy matching scores with corresponding weighting factors, and progressively updating a matching coefficient. If a finalized matching coefficient is above a predetermined threshold, a recommendation indicating a match is generated for a merchant user to confirm the match. If the finalized matching coefficient is below the predetermined threshold, no such recommendation is made.

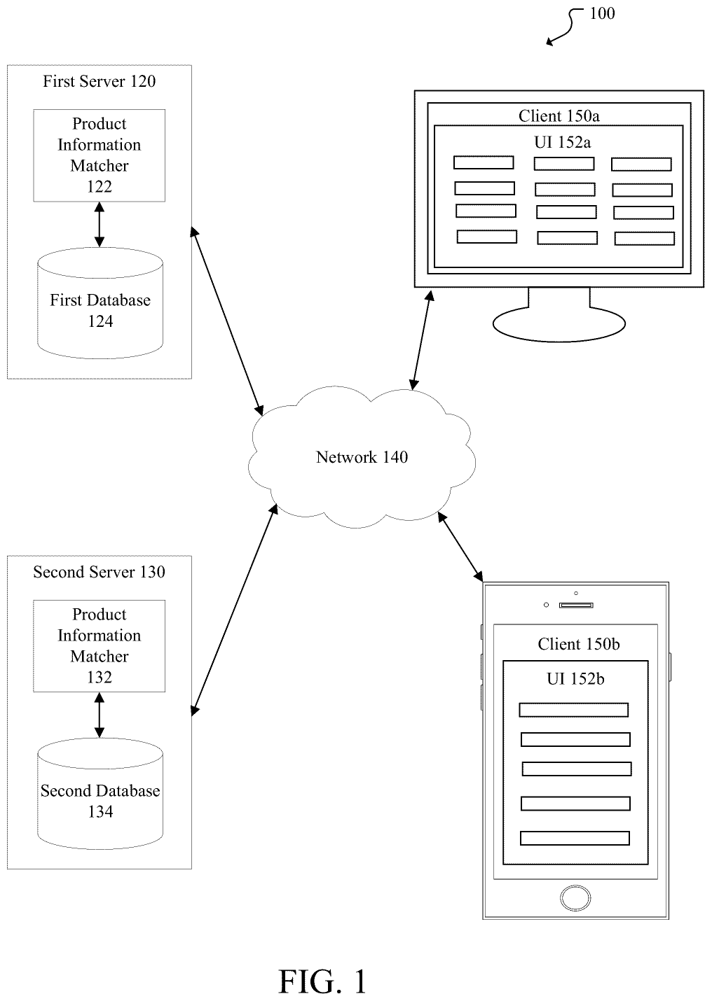

FIG. 1 shows an example of a system 100 configured for matching product information across multiple channels based on the principles disclosed herein. It should be understood that the components of the system 100 shown in FIG. 1 and described herein are merely examples and systems with additional, alternative, or fewer number of components should be considered within the scope of this disclosure.

As shown, the system 100 comprises client devices 150a, 150b (collectively referred to herein as “client devices 150”) and servers 120, 130 interconnected through a network 140. The first server 120 hosts a first product information matcher 122 and a first database 124 and the second server 130 hosts a second product information matcher 132 and a second database 134. The client devices 150a, 150b have user interfaces 152a, 152b, respectively, (collectively referred to herein as “user interfaces (UIs) 152”) that may be used to communicate with the product information matchers 122, 132 via the network 140. For example, communication between the different components of the system 100 is facilitated by one or more application programming interfaces (APIs). APIs of system 100 may be proprietary and or may include such APIs as Amazon® Web Services (AWS) APIs or the like. The network 140 may be the Internet and or other public or private networks or combinations thereof. The network 140 therefore should be understood to include any type of circuit switching network, packet switching network, or a combination thereof. Non-limiting examples of the network 140 may include a local area network (LAN), metropolitan area network (MAN), wide area network (WAN), and the like.

Client devices 150 may include any device configured to present user interfaces (UIs) 152 and receive user inputs. The client devices 150 may generally be used by merchant users that have subscribed to the system 100 to access the product information matchers 122, 132. To that end, the Uls 152 provide UI tools such as dialog boxes, forms, or other widgets for the merchant users to enter commands to the product information matchers 122, 132 and receiving recommended matches. For example, a merchant user may instruct the product information matcher 122 through the UI 152a to determine whether received product information matches stored product information. When the product information matcher 122 determines that there is a match (as indicated by a matching coefficient being above a threshold), the product information matcher 122 generates an output on the UI 152a showing the recommended matches.

As described throughout this disclosure, the product information matchers 122, 132 perform the matching operation by fuzzy matching different attributes of the received product information and the stored product information, e.g., stored at the database 124, 134. The generated fuzzy matching scores are then weighted by corresponding weighting factors. The weighted fuzzy matching scores are used to progressively update a matching coefficient. When the matching coefficient is finalized, it is compared to a threshold. If the matching coefficient is above the threshold, a recommended match is shown at the Uls 152. If the matching coefficient is below the threshold, no such recommendation is shown.

First server 120, second server 130, first database 124, second database 134, and client devices 150 are each depicted as single devices for ease of illustration, but those of ordinary skill in the art will appreciate that first server 120, second server 130, first database 124, second database 134, and or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one or two) servers. In another example, a plurality of client devices 150 may communicate with first server 120 and/or second server 130. A single user may have multiple client devices 150, and/or there may be multiple users each having their own client devices 150.

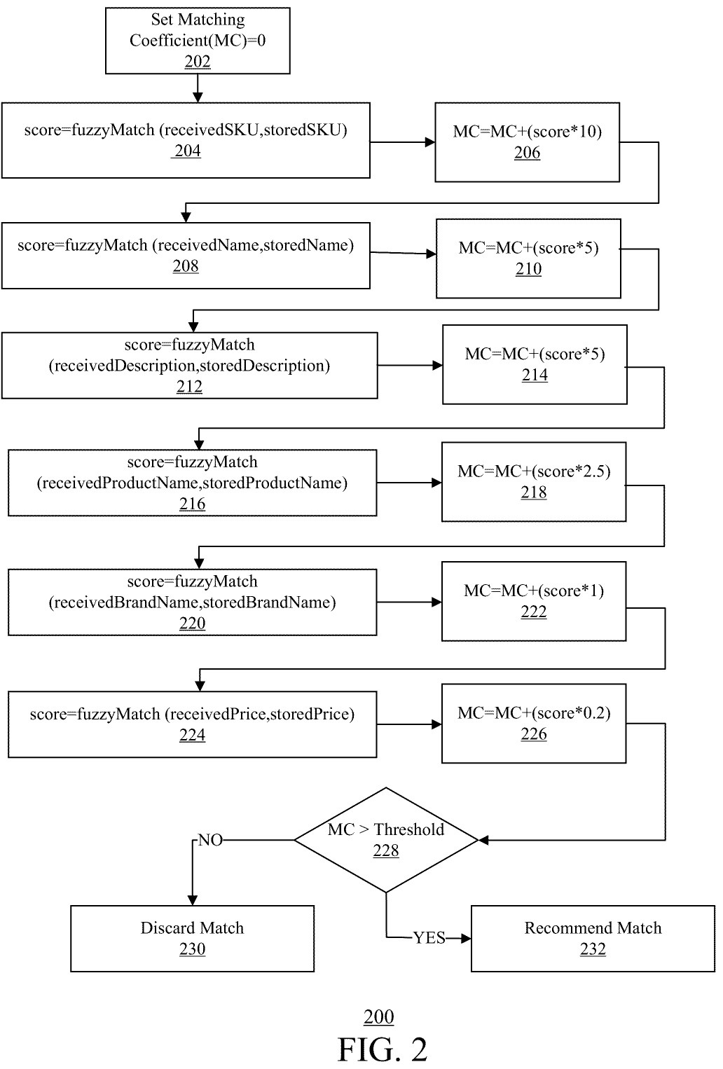

FIG. 2 shows a flow diagram of an example method 200 of matching product information across different channels based on the principles disclosed herein. It should be understood that the steps of the method 200 are merely intended as examples and should not be considered limiting. Furthermore, the illustrated sequence of steps is used for explanatory purposes and should not be considered limiting. That is, methods with additional, alternate, or fewer number of steps should also be considered within the scope of this disclosure. One or more steps of the method 200 may be performed by one or more components of the system 100 shown in FIG. 1.

Furthermore, the single cycle comparison between received product information and stored product information described below is for illustration purposes only. The received product information can be compared to all or a subset of stored product information based on the principles disclosed herein. In one or more embodiments, the comparison may continue until a match is found. Therefore, the method 200 may form a nucleus of a matching operation that may be deployed to perform any number and/or any type of matching. In one or more embodiments, the matching is used for product deduplication. That is, received product information that matches the stored product information can be considered duplicative of the stored product information. The matching will avoid duplicate records when product information comes through multiple channels.

The method 200 begins at step 202, where a matching coefficient (MC) is set to zero. The matching coefficient numerically indicates a level of matching between the received product information and the stored product information. For example, the matching coefficient indicates whether the received product information can be considered a duplicate of the stored product information. The setting of the matching coefficient to zero at step 202 is therefore an initialization step prior to a comparison. The subsequent steps update the matching coefficient based on comparing different attributes within the received product information with corresponding attributes within the stored product information.

At step 204, a fuzzy matching score (score) is calculated by fuzzy matching a SKU within the received product information with a SKU within the stored product information. The fuzzy matching at this step and subsequent steps may be performed by any kind of matching algorithm. In one or more embodiments, the fuzzy matching algorithm may include a Jaro-Winkler matching algorithm, which is known in the art, and therefore will not be described in detail here.

At step 206, the matching coefficient is updated based on the fuzzy matching score calculated at step 204. The calculated fuzzy matching score is weighted by a weighting factor, 10 in the shown example, and added to the matching coefficient (i.e., MC=MC+(score*10)). The weighting factor is high because a match between the SKUs indicates that is highly likely that the received product information matches the stored product information. While different channels may use different identification numbers, a product SKU tends to remain the same across different channels, and therefore a match between the SKUs is generally weighted higher compared to other attributes.

At step 208, the fuzzy matching score calculated at step 204 is replaced by the fuzzy matching score calculated by fuzzy matching a received name of the product information with a stored name of the product information. The name of the product information may not necessarily be the name of the product itself, but an identifier of the product information. For example, all types of candles—while having different varieties of specific names—can be generically named as a “candle” within the product information.

At step 210, the matching coefficient is updated based on the fuzzy matching score calculated at step 208. As with the previous update to the matching coefficient, the fuzzy matching score is weighted by a factor, as shown the weighting factor is 5, and added to the matching coefficient (i.e., MC=MC+ (score*5)). The name of the product information may be less reliable than the SKUs because the same generic name can be used for different products across the different channels. For example, “candle” can be used to refer to both scented candle and unscented candle products.

At step 212, the fuzzy matching score calculated at step 208 is replaced by a fuzzy matching score calculated by fuzzy matching a received description of the product with the stored description of the product. The description generally includes a short paragraph or a marketing blurb introducing the product to potential customers and encouraging them to buy the product. The description generally tends to be similar for a product across the different channels, e.g., the description may use same words and phrases.

At step 214, the matching coefficient is updated based on the fuzzy matching score calculated at step 212. As with the previously calculated fuzzy matching scores, the current fuzzy matching score is weighted by a factor, the shown weighting factor is 5, and added to the matching coefficient (i.e., MC=MC+ (score*5)). As shown, the weighting factor for the description is the same as the name of the product information, as both of these attributes may be similar across different channels with a similar confidence level. The description of the product is weighted higher than the actual name of the product because e.g., the same product name with catchy phrases can be used for different products to entice customers.

At step 216, the fuzzy matching score calculated at step 212 is replaced by fuzzy matching score calculated by fuzzy matching a received product name and stored product name. A similar product name can be used for different products, therefore the product name itself may not necessarily be as reliable as the SKU and the description.

At step 218, the matching coefficient is updated based on the fuzzy matching score calculated at step 216. This calculated fuzzy matching score is weighted by a factor, e.g., as shown, the weighting factor is 2.5, and added to the matching coefficient (i.e., MC=MC+ (score*2.5)). Because the product name (e.g., with catchy and pithy phrases) may likely be similar for different products, the matching of product names has a lower confidence level compared to the product descriptions or the generic name discussed above.

At step 220, the fuzzy matching score calculated at step 216 is replaced by a fuzzy matching score calculated by fuzzy matching a received brand name and a stored brand name. It is well known that a brand name may have multiple products, making the brand name less reliable for the product matching.

At step 222, the matching coefficient is updated based on the fuzzy matching score calculated at step 220. Similar to the steps above, the fuzzy matching score is weighted by a factor, the shown weighting factor is 1, and added to the matching coefficient (i.e., MC=MC+ (score*1)). Because a single brand name can be used for different products, the confidence level of actual product information match based on the match between the brand names is low, and hence a small weighting factor.

At step 224, the fuzzy matching score calculated at step 220 is replaced by a fuzzy matching score calculated by fuzzy matching a received price with a stored price. There may be a possibility that the same product is listed across the different channels with the same price point, and therefore a match between prices may indicate the same product.

At step 226, the matching coefficient is updated based on the fuzzy matching score calculated at step 224. As the different products may be offered at the same price point across the different channels, the matching between the prices generally has a lower confidence level. Therefore, this matching has a smaller weighting factor of 0.2 (i.e., MC=MC+ (score*0.2)).

At step 228, a comparison is made to determine whether the calculated matching coefficient is above a predetermined threshold. If the calculated matching coefficient is not above the predetermined threshold (i.e., a no at step 228), the method proceeds to step 230 where the match is discarded. If the calculated matching score is above the predetermined threshold (i.e., a yes at step 228), step 232 is executed to recommend the match, e.g., by showing the recommended match in a graphical user interface, as described below.

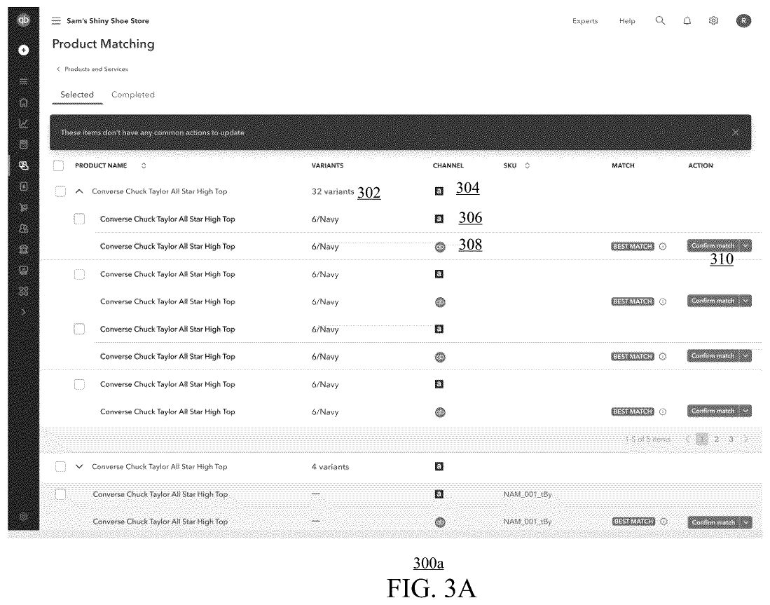

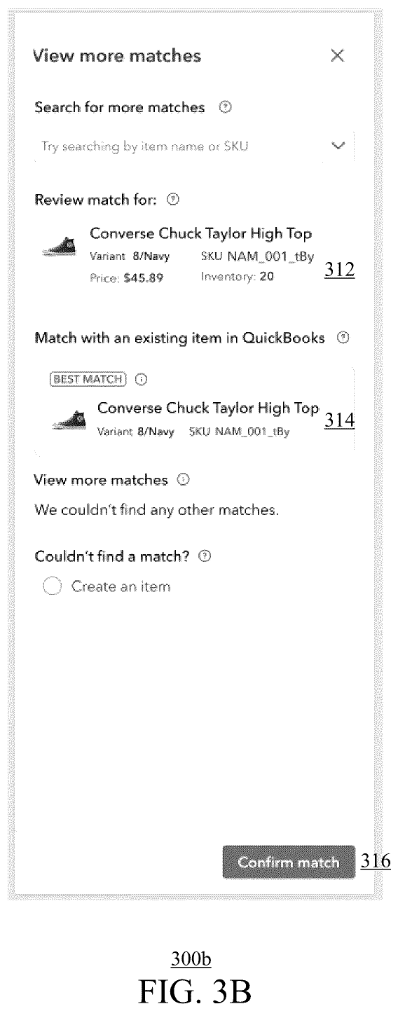

FIGS. 3A-3B show example graphical user interfaces 300a, 300b showing recommended matches based on the principles disclosed herein. It should be understood that the illustrated graphical user interfaces 300a, 300b are just examples, and should not be considered limiting. Other types of graphical user interfaces showing the same or similar information should be considered within the scope of this disclosure.

As shown in the first graphical user interface 300a, there may be thirty-two matching variants 302 for a single product 304 (“Converse Chuck Taylor All Star High Top”). Out of the thirty-two variants, one variant may come from a first channel 306 (shown by a graphical “a” representing Amazon®) and another variant may be stored at a local storage 308 (via QuickBooks® shown by a graphical “qb” in the example). As the variant from the first channel 306 matches the variant stored at the local storage 308, an option 310 is provide for a merchant user to confirm the shown (i.e., recommended) match.

As shown in the second graphical user interface 300b, a match has been found between first product information 312 received from a first channel and second product information 314 stored locally (e.g., by QuickBooks®). As shown, the match is a recommended match, and the merchant user is prompted to confirm the match using an option 316. In one or more embodiments, the confirmation step may be skipped.

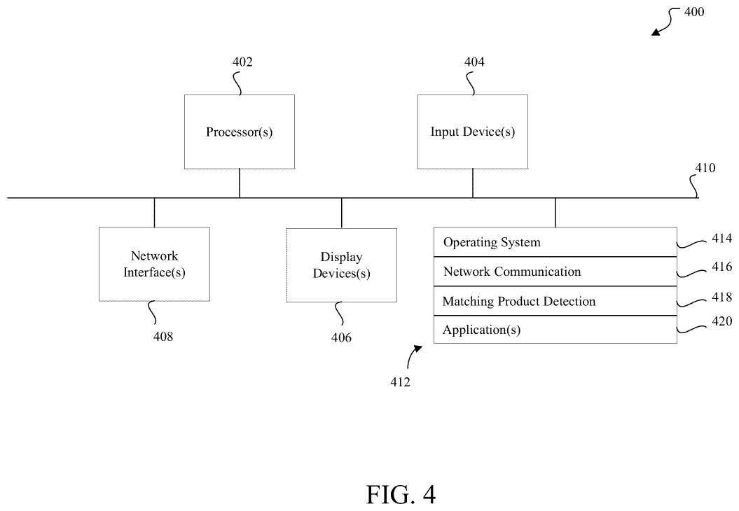

FIG. 4 shows a block diagram of an example computing device 400 that implements various features and processes based on the principles disclosed herein. For example, computing device 400 may function as first server 120, second server 130, client 150a, client 150b, or a portion or combination thereof in some embodiments. The computing device 400 also performs one or more steps of the method 200. The computing device 400 is implemented on any electronic device that runs software applications derived from compiled instructions, including without limitation personal computers, servers, smart phones, media players, electronic tablets, game consoles, email devices, etc. In some implementations, the computing device 400 includes one or more processors 402, one or more input devices 404, one or more display devices 406, one or more network interfaces 408, and one or more computer-readable media 412. Each of these components is be coupled by a bus 410.

Display device 406 includes any display technology, including but not limited to display devices using Liquid Crystal Display (LCD) or Light Emitting Diode (LED) technology. Processor(s) 402 uses any processor technology, including but not limited to graphics processors and multi-core processors. Input device 404 includes any known input device technology, including but not limited to a keyboard (including a virtual keyboard), mouse, track ball, and touch-sensitive pad or display. Bus 410 includes any internal or external bus technology, including but not limited to ISA, EISA, PCI, PCI Express, USB, Serial ATA or FireWire. Computer-readable medium 412 includes any non-transitory computer readable medium that provides instructions to processor(s) 402 for execution, including without limitation, non-volatile storage media (e.g., optical disks, magnetic disks, flash drives, etc.), or volatile media (e.g., SDRAM, ROM, etc.).

Computer-readable medium 412 includes various instructions 414 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 404; sending output to display device 406; keeping track of files and directories on computer-readable medium 412; controlling peripheral devices (e.g., disk drives, printers, etc.) which can be controlled directly or through an I/O controller; and managing traffic on bus 410. Network communications instructions 416 establish and maintain network connections (e.g., software for implementing communication protocols, such as TCP/IP, HTTP, Ethernet, telephony, etc.).

Matching product detection 418 include instructions that implement the disclosed process for identifying a stored product information that matches a received product information and recommending the match to a merchant user.

Application(s) 420 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A method performed by a processor, said method comprising:
receiving product information associated with a first product from a first network-based channel and comprising a plurality of text attributes specific to the first network-based channel, the first product being provided by a user, the first network-based channel being one of multiple network-based channels hosting the first product with corresponding pluralities of specific text attributes;
comparing the received product information with stored product information stored at a local storage and associated with a second product, provided by the user, by:
fuzzy matching the received plurality of text attributes with a corresponding plurality of stored text attributes, the fuzzy matching generating a plurality of fuzzy matching scores;
initializing a matching coefficient by setting the matching coefficient to zero before comparing the received product information with the stored product information; and
progressively updating the matching coefficient using weighted forms of the plurality of fuzzy matching scores;
outputting, on a graphical user interface, a recommendation indicating a match between the first product and the second product based on determining that the matching coefficient exceeds a predetermined threshold, the graphical user interface further displaying additional variants of the first product or the second product, the displayed additional variants of the first product coming from the plurality of network-based channels or from the local storage;
outputting, on the graphical user interface, the recommendation as a best matched recommendation; and
deduplicating between the first product and the second product for the user responsive to the user accepting the recommendation.

2. (canceled)

3. The method of claim 1, further comprising:
discarding the recommendation based on determining that the matching coefficient is below the predetermined threshold.

4. (canceled)

5. The method of claim 1, further comprising:
using a first weighting factor for a first fuzzy matching score of the plurality of matching scores, the first fuzzy matching score generated by comparing a first attribute of the plurality of attributes and a corresponding second attribute of the plurality of stored attributes; and
using a second weighting factor for a second fuzzy matching score of the plurality of matching scores, the second fuzzy matching score generated by comparing a third attribute of the plurality of attributes and a corresponding fourth attribute of the plurality of stored attributes, the first weighting factor being less than the second weighting factor.

6. The method of claim 1, the receiving product information comprising:
receiving the plurality of attributes comprising at least one of a numerical identifier of the first product, description of the first product, name of the first product, brand name of the first product, or price of the first product.

7. The method of claim 1, the fuzzy matching comprising:
using Jaro-Winkler distances between the received plurality of attributes and the corresponding plurality of stored attributes to perform the fuzzy matching.

8. A system comprising:
a non-transitory storage medium storing computer program instructions; and
one or more processor configured to execute the computer program instructions to perform operations comprising:
receiving product information associated with a first product from a first network-based channel and comprising a plurality of text attributes specific to the first network-based channel, the first product being provided by a user, the first network-based channel being one of multiple network-based channels hosting the first product with corresponding pluralities of specific text attributes;
comparing the received product information with stored product information stored at a local storage and associated with a second product, provided by the user, by:
fuzzy matching the received plurality of text attributes with a corresponding plurality of stored text attributes, the fuzzy matching generating a plurality of fuzzy matching scores;
initializing a matching coefficient by setting the matching coefficient to zero before comparing the received product information with the stored product information; and
progressively updating the matching coefficient using weighted forms of the plurality of fuzzy matching scores;
outputting, on a graphical user interface, a recommendation indicating a match between the first product and the second product based on determining that the matching coefficient exceeds a predetermined threshold, the graphical user interface further displaying additional variants of the first product or the second product, the displayed additional variants of the first product coming from the plurality of network-based channels or from the local storage;
outputting, on the graphical user interface, the recommendation as a best matched recommendation; and
deduplicating between the first product and the second product for the user responsive to the user accepting the recommendation.

9. (canceled)

10. The system of claim 8, the operations further comprising:
discarding the recommendation based on determining that the matching coefficient is below the predetermined threshold.

11. (canceled)

12. The system of claim 8, the operations further comprising:
using a first weighting factor for a first fuzzy matching score of the plurality of matching scores, the first fuzzy matching score generated by comparing a first attribute of the plurality of attributes and a corresponding second attribute of the plurality of stored attributes; and
using a second weighting factor for a second fuzzy matching score of the plurality of matching scores, the second fuzzy matching score generated by comparing a third attribute of the plurality of attributes and a corresponding fourth attribute of the plurality of stored attributes, the first weighting factor being less than the second weighting factor.

13. The system of claim 8, the receiving product information comprising:
receiving the plurality of attributes comprising at least one of a numerical identifier of the first product, description of the first product, name of the first product, brand name of the first product, or price of the first product.

14. The system of claim 8, the fuzzy matching comprising:
using Jaro-Winkler distances between the received plurality of attributes and the corresponding plurality of stored attributes to perform the fuzzy matching.

15. A non-transitory storage medium storing computer program instructions that when executed cause operations comprising:
receiving product information associated with a first product from a first network-based channel and comprising a plurality of text attributes specific to the first network-based channel, the first product being provided by a user, the first network-based channel being one of multiple network-based channels hosting the first product with corresponding pluralities of specific text attributes;
comparing the received product information with stored product information stored at a local storage and associated with a second product, provided by the user, by:
fuzzy matching the received plurality of text attributes with a corresponding plurality of stored text attributes, the fuzzy matching generating a plurality of fuzzy matching scores;
initializing a matching coefficient by setting the matching coefficient to zero before comparing the received product information with the stored product information; and
progressively updating the matching coefficient using weighted forms of the plurality of fuzzy matching scores;
outputting, on a graphical user interface, a recommendation indicating a match between the first product and the second product based on determining that the matching coefficient exceeds a predetermined threshold, the graphical user interface further displaying additional variants of the first product or the second product, the displayed additional variants of the first product coming from the plurality of network-based channels or from the local storage;
outputting, on the graphical user interface, the recommendation as a best matched recommendation; and
deduplicating between the first product and the second product for the user responsive to the user accepting the recommendation.

16. (canceled)

17. The non-transitory storage medium of claim 15, the operations further comprising:
discarding the recommendation based on determining that the matching coefficient is below the predetermined threshold.

18. (canceled)

19. The non-transitory storage medium of claim 15, the operations further comprising:
using a first weighting factor for a first fuzzy matching score of the plurality of matching scores, the first fuzzy matching score generated by comparing a first attribute of the plurality of attributes and a corresponding second attribute of the plurality of stored attributes; and
using a second weighting factor for a second fuzzy matching score of the plurality of matching scores, the second fuzzy matching score generated by comparing a third attribute of the plurality of attributes and a corresponding fourth attribute of the plurality of stored attributes, the first weighting factor being less than the second weighting factor.

20. The non-transitory storage medium of claim 15, the receiving product information comprising:
receiving the plurality of attributes comprising at least one of a numerical identifier of the first product, description of the first product, name of the first product, brand name of the first product, or price of the first product.
